(19) United States
(12) Patent Application Publication
(10) Pub. No.: US 2010/0028497 A1
(43) Pub. Date: Feb. 4, 2010

(54) METHOD OF PRODUCING AN EXTRUDED FOOD PRODUCT

(75) Inventors: Mohamed Erraji, Vitry Sur Seine (FR); Veronique Venet, Saint Germain Les Corbeil (FR); Edouard Page, Longjumeau (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Generale Biscuit

(21) Appl. No.: 12/201,527

(22) Filed: Aug. 29, 2008

(30) Foreign Application Priority Data
Aug. 1, 2008 (FR) 08/04433

(51) Int. Cl. A21D 13/00; A21D 2/08

(52) U.S. Cl. 426/94; 426/272; 426/89; 426/103

(57) ABSTRACT

The invention provides a method of producing an extruded food product, wherein, in order to deposit inclusions on the surface, the method comprises, downstream from at least one extrusion die producing a ribbon of extruded and expanded dough:
a) depositing on the surface at least one layer of a food quality adhesive that adheres instantly;
b) depositing on the surface inclusions comprising at least one type of inclusion;
c) pre-cutting the ribbon of dough;
d) drying and toasting the ribbon of dough;
e) breaking the dough into individual extruded pieces of bread;
f) cooling the individual extruded pieces of bread; and
the method further comprises, before a) and between b) and c), rolling the extruded ribbon of dough.

The present invention relates to a method of producing an extruded food product.

### CROSS REFERENCE TO RELATED APPLICATIONS

This application claims priority from French application number 08/04433, filed Aug. 1, 2008.

### BACKGROUND OF THE INVENTION

Many cookie products have surface inclusions, in particular seeds, cereals, fruit, grated cheese, or herbs, etc.

In the field of extruded food products such as the product sold under the trade name “Cracotte”, there is currently no method that can coat the product with inclusions and there is currently no extruded flatbread (obtained by extrusion cooking) on the market containing inclusions even though the first extruded flatbread (obtained by extrusion cooking) appeared at the end of the 1970s.

In contrast, products containing inclusions are quite common in the bread or biscotti market.

In methods of extrusion cooking extruded flatbreads, the raw materials are entrained in the extruder by a rotating Archimedes screw system and are subjected to large shear and compressive forces associated with a rise in temperature and pressure.

At the exit from the extruder, the raw material passes through a die that defines the shape of the product.

At the exit from the die, the pressure differential between the inside and the outside causes evaporation of water and expansion, endowing the product with an aerated texture. That method renders producing extruded products with inclusions difficult.

Adding an inclusion to the dough upstream from the extruder means that the inclusions cannot remain intact. Since the dough expands considerably during extrusion, the extrusion slot in the die is narrow (height of the order of 1.5 mm [millimeter] to 2 mm) while the size of the inclusions (seeds, pieces of fruit, etc) is at least 1 mm. In particular, seeds exude fats as they pass through the die where the majority of them are shredded, resulting in a very hard texture for the product.

### OBJECT OF THE INVENTION

The invention aims to propose a method that can deposit inclusions on the surface of an extruded food product without modifying the parameters of a method which, a priori, is less than propitious as regards producing such a result since it involves a high conveyor speed and the presence of vibration in the vertical direction.

The invention does not concern inclusions that may adhere to the support by themselves either at ambient temperature or in the molten state, such as chocolate chips, caramel or molten sugars, and liquid or semi-liquid cheeses that would adhere to the support by themselves without the need for an adhesive agent.

In the context of bakery or cookie production, cereals or grains are added to the surface of products by simple deposition and by pressing them partially into the surface of the dough pieces. The texture of the dough pieces is still elastic and allows the seeds and/or cereals to adhere, with this being facilitated by cooking which raises the dough and fixes that adhesion. Such an application process cannot be used in the present invention since the product is already cooked.

In cookie making, it is possible to use the same principle as is used for bread or biscotti for the purpose of adding cereals to the surface of a cookie. In addition, a glaze is routinely added that facilitates adhesion of such surface inclusions to the cookie and that gives the cookie a golden color. That process is not applicable when a non-colored product is required.

The texture of flatbread obtained by extrusion cooking does not allow adhesion simply by depositing and pushing inclusions into the surface of the product. The product has a texture that is poor as regards elasticity and adhesivity since it has already been cooked. It is not possible to make inclusions adhere to the surface simply by depositing them. It would be necessary to apply pressure that modifies the texture of the product completely, the product would no longer be aerated, and it would become very thin, which is not the desired outcome.

In the field of extruded snack products, surface inclusions are principally added using a fat as an adhesive agent. The liquid fat is sprayed onto the surface of the extruded product, usually in a drum. The products obtained are covered with inclusions on both faces. That method does not allow coarse particles to adhere. It is used in particular to adhere inclusions that are the powder form, with a size of less than 500 μm [micrometer], in particular flavorings.

The various above-mentioned processes and methods cannot, however, be used to accomplish the aim of the invention which is to obtain a food product that is obtained by extrusion cooking and that is covered with visible and perceptible inclusions.

There is currently no extrusion cooked flatbread type product covered with visible and perceptible inclusions.

### BRIEF SUMMARY OF THE INVENTION

The invention provides a method of producing an extruded food product, wherein, in order to deposit inclusions on the surface, the method comprises, downstream from at least one extrusion die producing a ribbon of extruded and expanded dough:

a) depositing on the surface at least one layer of a food quality adhesive that adheres instantly;

b) depositing on the surface inclusions comprising at least one type of inclusion;

c) drying the ribbon of dough;

d) breaking the dough into individual extruded pieces of bread;

e) cooling the individual extruded pieces of bread; and

the method further comprises, before a) and between b) and c), rolling the extruded ribbon of dough.

Surprisingly, using an adhesive with an instant adhesive effect provides sufficient adhesion of the inclusions to the surface of the ribbon despite its speed (of the order of 50 m/min [meters/minute] for the type of product envisaged) and despite the vibration of the extruded ribbon, which still has a certain amount of flexibility at the exit from the die.

A pre-cutting step may also be carried out before the surface deposition step a) or between steps b) and c), in particular to produce transverse pre-cut lines.

The adhesive may advantageously be based on at least one hydrocolloid, especially a polysaccharide and more particularly from polysaccharides of at least a starch and/or a glucose syrup and/or a maltodextrin and/or based on xanthan gum. The starch or starches are preferably not starches that have been chemically modified within the meaning of EC Directive N° 95/2/EC.

The method may involve superimposing a second ribbon of extruded and expanded dough which may optionally be covered with inclusions, on a first ribbon of extruded and expanded dough covered with inclusions.

The extrusion die may have a serrated profile to form striations on the upper surface of the ribbon onto which the inclusions are deposited.

The die may have a shallow U-shaped profile to form edges that are raised on either side of the ribbon of extruded and expanded dough.

The inclusions may in particular comprise seeds and/or cereals and/or pieces of fruit and/or cheese, either powdered or grated, in the solid state, and/or herbs. The largest dimension of the inclusions may be in the range 1 mm to 10 mm, in particular in the range 1 mm to 5 mm, and more particularly in the range 1 mm to 4 mm.

The invention also provides a product that may be obtained by the method defined above and comprising a support in the form of a flatbread obtained by extrusion cooking, an adhesive, in particular based on hydrocolloids, preferably polysaccharides, as well as visible inclusions.

Preferably, the adhesive is fat-free.

The adhesive may be based on maltodextrin and/or glucose syrup and/or starch. In particular, the adhesive is based on a glucose syrup with a dextrose equivalent in the range 18 to 48, preferably in the range 20 to 40 and more preferably in the range 20 to 23 and/or based on a maltodextrin with a dextrose equivalent of 20 or less, preferably in the range 5 to 10 and more preferably in the range 4 to 8.

The inclusions may comprise seeds and/or cereals and/or pieces of fruit and/or cheese, either powdered or grated, in the solid state, and/or herbs, wherein the largest dimension is in the range 1 mm to 10 mm, in particular in the range 1 mm to 5 mm, and more particularly in the range 1 mm to 4 mm.

The product may have by the following dimensions: a length in the range 50 mm to 130 mm, a width in the range 45 mm to 65 mm, and a thickness in the range 5 mm to 9 mm.

### BRIEF DESCRIPTION OF THE DRAWINGS

Other features and advantages of the invention become apparent from the following description, made with reference to the accompanying drawings in which:

FIG. 1 is a diagram of a production line in accordance with the invention; and

FIG. 2 represents a product obtained by the method of the invention respectively in section (FIG. 2a) and viewed from the top (FIG. 2b).

### MORE DETAILED DESCRIPTION

The method involves depositing adhesive on the surface, in particular by spraying, using a nozzle spray, the nozzle or nozzles being distributed across the width of the product. The adhesive comprises one or more adhesive agents forming a sprayable solution.

The adhesive used is preferably fat-free. The adhesive agent may be the majority of hydrocolloids that have a thickening, stabilizing or gelling effect which, in solution, result in the formation of a solution having an adhesive effect. Hydrocolloids that can in particular be used are polysaccharides including starches and their derivatives, fruit pectins, xanthans, alginates, carragheenans, guar gums, and carouba gum, as well as gelatins and soluble fibers (FOS and inulin may also be classified with polysaccharides).

Said hydrocolloids may be used alone or in combination.

Some adhesive formulations are given below by way of example:

dehydrated glucose syrup (dextrose equivalent DE=21); the adhesive is obtained by adding 1 kg [kilogram] of said dehydrated product to 1 L [liter] of water at 55° C.;

pre-gelatinized modified starch: the adhesive is obtained by adding 50 g [gram] of pre-gelatinized modified starch to 1 L of cold water;

culinary fluidized starch; the adhesive is obtained by adding 300 g of culinary fluidized starch to 1 L of cold water;

maltodextrin: the adhesive is obtained by adding 260 g of maltodextrin to 1 L of cold water;

xanthan gum: the adhesive is obtained by adding 6 g of xanthan gum to 1 L of cold water.

The adhesives mentioned above produce satisfactory levels of adhesion. However, the starches suffer from the disadvantage of having a whitish or brownish color that is not favorable to the appearance of the product. Thus, fluidized starch produces the poorest result as regards adhesion. The best results are thus obtained using glucose syrup, xanthan gum, and maltodextrin. Water alone cannot bond the inclusions.

The inclusions may be poppy seeds, quinoa seeds, and/or millet seeds (dimensions in the range 1 mm to 1.5 mm), and/or brown linseed, yellow linseed, sesame seeds, pine kernels, and/or cracked wheat, oats and/or rye and/or buckwheat (dimensions in the range 1 mm to 4 mm) and/or wheat, oats, barley and/or spelt and/or rye flakes (dimensions over 5 mm), and/or sunflower seeds, and/or pumpkin seeds, oats, barley and/or wheat flakes (dimensions of the order of 8 mm), and/or pieces of grated or powdered cheese (dimensions in the range 5 mm to 10 mm).

The adhesive capacity of the seeds is higher when the dimensions are smaller (for example poppy seeds, sesame seeds or linseed). For flakes, adhesion is good since even though their dimensions may be greater than those of seeds, the relative flatness of their surfaces is a factor that favour adhesion. Sunflower and pumpkin seeds have the poorest adhesion because of their size and their convex shape. Further, it has been observed that sunflower seeds are crushed under the pressure of the cylinder rolls and lose some of their integrity. As regards diced fruit, it has been observed with raspberry fragments that the cylinder rolls and the pre-cutting knife are fouled due to adhesion of the raspberry fragments to their surfaces, to the detriment of the product.

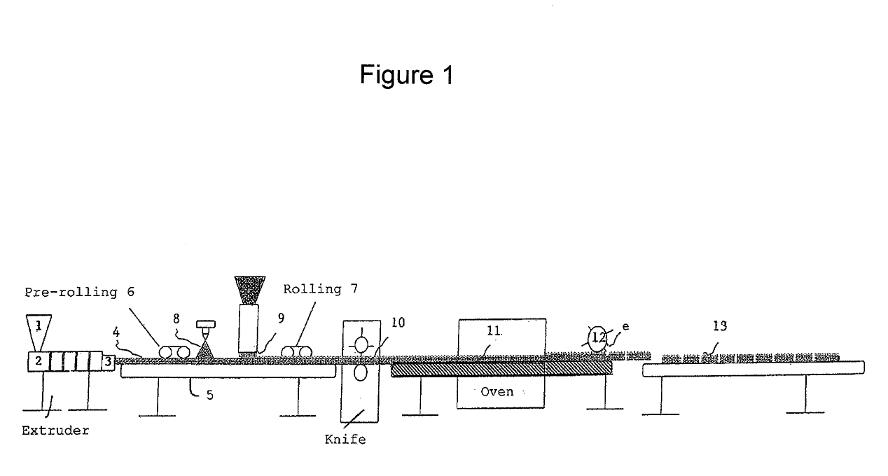

Referring to FIG. 1, the method employs the following steps:

mixing the powders at 1 and feeding the extrusion cooker 2;

cooking and extrusion through a die 3. The departing product is shaped into the form of a highly expanded continuous ribbon 4. The ribbon 4 leaving the die is guided by a conveyor 5;

guiding, pre-rolling and stretching using one or more cylindrical rolls 6. Pre-rolling smooths the surface of the extruded dough, calibrates it to a given thickness and renders it flat;

at 8, surface depositing a film of adhesive, preferably by spraying, in one or two layers;

at 9, depositing inclusions for example using an endless screw metering device;

rolling using one or more cylindrical rolls 7. The distance between the cylinder rolls and the extruded base is selected so as to exert a bearing force on the inclusions to reinforce their adhesion to the surface of the extruded dough. The distance must remain sufficient to avoid compressing the product, which would significantly modify the initial texture of the extruded base. In this step, while the outer “crust” of the product is deformable, it is not possible to deform it permanently. In contrast, the core of the product retains a certain amount of elasticity, which means that this rolling operation can be carried out without damaging the inclusions. This elasticity disappears once the product has dried and cooled. This step can also limit the loss of inclusions due to the high throughput speed and the vibration to which the ribbon of dough is subjected;

optional pre-cutting, in particular by forming transverse striations in the upper surface of the ribbon using knives 10 to define individual extruded pieces of bread;

drying by toasting lightly in an infrared oven 11 (for example with a mean oven temperature of 250° C. for 15 s [seconds] to 30, for example) This step can reduce the moisture content of the product and produce a final moisture content in the range 3% to 5%;

at 12, breaking or cutting into individual extruded pieces of bread;

at 13, cooling the individual extruded pieces of bread at, especially with a view to packaging them.

The method can distribute the inclusions over the surface without forming agglomerates of inclusions.

The strong adhesion that is produced instantaneously by an instant liquid adhesive can, because of its syrupy consistency, mean that the inclusions withstand both the speed of the extruded ribbon and the vertical vibration to which the ribbon is subjected, which ribbon has a certain amount of flexibility on exit from the extruder.

The vertical vibration has the effect of continuously battering the ribbon with an amplitude of several millimeters, which tends to eject the inclusions that are deposited on the ribbon.

Downstream, the vibration is no longer present since the ribbon is guided by the conveyor and the adhesive syrup dries progressively, increasing its adhesive power.

The method can be integrated in conventional manner into a line that includes a plurality of exits for extruded dough.

Under such circumstances, it is possible to produce a sandwich comprising a first product that is covered with inclusions and a second product that may optionally be covered with inclusions.

To this end, two strips that are originally located side by side are superimposed by guiding them laterally.

The downstream rolling step is then carried out to produce the sandwich.

### EXAMPLE

Extruded products were produced in accordance with FIG. 1. An extruded base was rolled, then covered with a layer of adhesive (8), then covered with inclusions (9) and underwent another rolling step before being pre-cut (10), then dried and toasted in an oven (11); next, the products were cut into individual bread pieces (12) that were cooled (13).

The extruded base had the following composition (the proportions shown are proportions by weight):

TABLE 1
Formula for dough or extruded base

| Ingredients | Quantity (%) |
|---|---|
| Wheat flour | 87 |
| Malted wheat | 4 |
| Powdered lactoserum | 3.5 |
| Sugar (saccharose) | 2.5 |
| Salt | 1.5 |
| African oil | 1.5 |
| Total | 100 |

Apart from the African oil, the ingredients making up the extruded base were mixed together then fed into the extrusion cooker. The African oil was injected into the extruder continuously, metered at 1.5%.

The adhesive had the following composition:

TABLE 2
Formula for adhesive

| Ingredients | Quantity (%) |
|---|---|
| Dehydrated glucose syrup (DE = 21) | 50 |
| Hot water (55° C.) | 50 |
| Total | 100 |

The adhesive obtained using the formula shown in Table 2 had the flow characteristics of a Newtonian liquid and its viscosity at 20° C. was 91 mPa·s [megapascal·second].

The mixture of inclusions had the following composition:

TABLE 3
Composition of mixture of inclusions

| Ingredients | Quantity (%) |
|---|---|
| Sesame seeds, shelled | 33 |
| Brown linseed | 33 |
| Baby oat flakes | 33 |
| Total | 100 |

The extruded base was obtained by feeding a twin screw extrusion cooker (for example the BC45 model from Clextral) with the mixture described in Table 1 without the African oil. The feed rate for the mixture was in the range 150 kg/h [kilograms/hour] to 180 kg/h. The African oil was added continuously during the extrusion cooking phase. Steam and/or water was also added continuously to encourage the formation of water bubbles and to encourage expansion. The mixture was cooked, and was then forced through a die that endowed the base with a rectangular sectional shape. The exit temperature of the extruded base was in the range 180° C. to 190° C. At the exit from the die, the cooked mixture expanded in contact with air to form a ribbon of expanded dough. The exit speed of the extruded ribbon was in the range 45 m/min to 50 m/min. The moisture content of the extruded base at the extruder exit was in the range 8.5% to 12%.

The extruded ribbon was then guided and entrained by a solid belt roller, then rolled using two cylindrical rolls (6—FIG. 1) that applied a pressure between the ribbon and the conveyor. This allowed the thickness of the extruded ribbon to be calibrated and endowed it with a smooth, regular surface.

Next, the adhesive prepared using the formula defined in Table 2 was sprayed as a continuous jet onto the surface of the extruded ribbon (8—FIG. 1). The amount of adhesive was in the range 1.5% to 10% and preferably in the range 3% to 5% (percentage per 100 g of finished product). Spraying was carried out to obtain a regular and homogeneous surface layer covering the extruded base over its entire width. The adhesive was colorless and transparent, and it provided a very slight sweet flavor. The moisture content of the product obtained (extruded base+adhesive) was in the range 9.5% to 12.5%.

The mixture of inclusions prepared using the formula described in Table 3 was added continuously to this extruded base covered with adhesive. The inclusions were metered continuously using a single screw volumetric metering device (9—FIG. 1). Continuous metering produced a constant ratio of extruded base to inclusions. The inclusions were deposited so as to cover the adhesive-covered extruded base over its entire width. The amount of inclusions can be in the range 1.5% to 20% and is preferably in the range 7.5% to 15%. Adding inclusions had little effect on the moisture content of the final product.

The inclusions adhered instantly to the surface when they came into contact with the adhesive-covered extruded base. To accentuate this adhesion, a rolling step using one or more cylindrical rolls was necessary (7—FIG. 1). Said rolling can also produce a regular and homogeneous surface and calibrate the thickness of the product.

A scraper system can be positioned on the conveyor where the steps of spraying the adhesive and depositing inclusions were carried out in order to recover adhesive residues and seed residues and thus prevent them from accumulating on the conveyor, since that could cause an interruption to the process. Similarly, an air spraying system is advantageously positioned before the base reaches the knife in order to eliminate surplus inclusions that could foul the knife and prevent it from functioning properly.

The product obtained was then pre-cut by a rotating blade knife (10—FIG. 1). The blades marked the upper face of the extruded base at the desired length (i.e. in the range 115 mm and 120 mm).

After said pre-cutting, the product was transported by a conveyor into an infrared oven (11—FIG. 1) that dried the product so as to bring its moisture content into the range 3% to 5% and so as to give it a natural golden color. The drying/toasting time was in the range 15 s to 30 s at a temperature in the range 200° C. to 250° C. Drying the product increased the adhesion of the inclusions that were then stuck to the surface of the extruded base. The dehydrated glucose syrup-based adhesive undergoes a small amount of crystallization that can result in a slight white color, but that was found to be hardly noticeable.

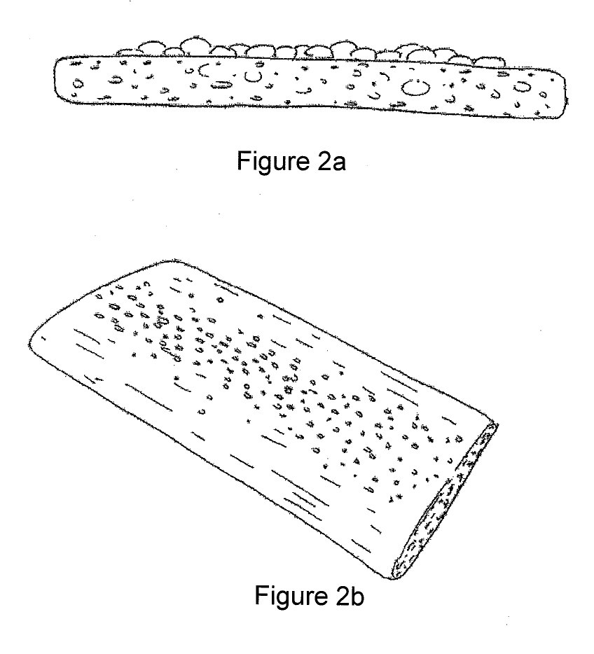

At the oven exit, the products were then broken (12—FIG. 1) to separate them into individual bread pieces that were cooled in the open air (13—FIG. 1) and that could then be packaged. The resulting product was as shown in FIGS. 2a and 2b. It was an extruded, expanded product covered with seeds and cereals that had a crisp, crunchy, and melt-in-the-mouth texture. The resulting product can be consumed as is, or it can be covered with a spread.

The formula for the extruded base can be composed of one or more cereals that may be whole cereals.

The mixture of inclusions can be composed of just one to more than 3 seeds and/or cereals and/or herbs and/or fruit and/or different pieces of cheese.

The adhesive can also be replaced by a maltodextrin with a dextrose equivalent that is preferably equal to 6, prepared by adding 260 mL [milliliters] to 300 mL of said maltodextrin to 1 L of water.

1. A method of producing an extruded food product, wherein, in order to deposit inclusions on the surface, the method comprises, downstream from at least one extrusion die producing a ribbon of extruded and expanded dough:
a) depositing on the surface at least one layer of a food quality adhesive that adheres instantly;
b) depositing on the surface inclusions comprising at least one type of inclusion;
c) drying the ribbon of dough;
d) breaking or cutting the ribbon of dough into individual extruded pieces of bread;
e) cooling the individual extruded pieces of bread; and
the method further comprises, before a) and between b) and c), rolling the extruded ribbon of dough.

2. A method according to claim 1, wherein between b) and c), it includes pre-cutting the ribbon of dough to define individual extruded dough pieces.

3. A method according to claim 1 or claim 2, wherein said pre-cutting involves producing transverse pre-cut lines for the individual extruded pieces of bread.

4. A method according to claim 1, wherein the adhesive is fat-free.

5. A method according to claim 1, wherein the adhesive is based on at least one hydrocolloid, in particular a polysaccharide and more particularly from polysaccharides of at least a starch and/or a glucose syrup and/or a maltodextrin.

6. A method according to claim 1, wherein the adhesive is based on xanthan gum.

7. A method according to claim 1, involving superimposing a second ribbon of extruded and expanded dough on a first ribbon of extruded and expanded dough covered with inclusions.

8. A method according to claim 1, wherein at least one extrusion die has a serrated profile to form striations on an upper face of the ribbon.

9. A method according to claim 1, wherein at least one extrusion die has a broad U-shaped profile to form edges that are raised on either side of the strips of extruded and expanded dough.

10. A method according to claim 1, wherein the inclusions comprise seeds and/or cereals and/or pieces of fruit and/or herbs and/or pieces of cheese.

11. A method according to claim 1, wherein the largest dimension of the inclusions is in the range 1 mm to 10 mm and in particular in the range 1 mm to 5 mm and more particularly in the range 1 mm to 4 mm.

12. A product that may be obtained by the method according to claim 1, comprising a support in the form of a flatbread obtained by extrusion cooking, an adhesive in particular based on hydrocolloids, preferably polysaccharides, and visible inclusions.

13. A product according to claim 12, wherein the adhesive is fat-free.

14. A product according to claim 12 or claim 13, wherein the adhesive is based on maltodextrin and/or glucose syrup and/or starch.

15. A product according to claim 14, wherein the adhesive is based on glucose syrup with a dextrose equivalent in the range 18 to 48, preferably in the range 20 to 40 and more preferably in the range 20 to 23.

16. A product according to claim 14, wherein the adhesive is based on a maltodextrin with a dextrose equivalent of 20 or less, preferably in the range 5 to 10 and more preferably in the range 4 to 8.

17. A product according to claim 11, where the product is covered with inclusions comprising seeds and/or cereals and/or pieces of fruit and/or cheese, either powdered or grated, in the solid state and/or herbs, wherein the largest dimension is in the range 1 mm to 10 mm, in particular in the range 1 mm to 5 mm, and more particularly in the range 1 mm to 4 mm.

18. A product according to claim 11, having the following dimensions: a length in the range 50 mm to 130 mm, a width in the range 45 mm to 65 mm, and a thickness in the range 5 m to 9 mm.
